(19) United States
(12) Patent Application Publication
(10) Pub. No.: US 2012/0055637 A1
(43) Pub. Date: Mar. 8, 2012

(54) TRANSPARENT SECURITY SHUTTER

(75) Inventors: Jean Louis Marinetti, Allauch (FR); Stephan Sciapapietra, Marseille (FR)

(73) Assignee: PROFILMAR, Marseille (FR)

(21) Appl. No.: 13/319,191

(22) PCT Filed: May 7, 2010
(86) PCT No.: PCT/FR2010/000355

§ 371 Date: Nov. 7, 2011

(30) Foreign Application Priority Data
May 7, 2009 (FR) 0902241

(51) Int. Cl. E06B 9/15

(52) U.S. Cl. 160/133

(57) ABSTRACT

The present invention relates to a transparent security shutter, of the type that can be wound about a drum arranged at the top thereof, said shutter being made up of a plurality of transparent slats (3), arranged horizontally on top of one another, and each connected to the immediately higher slat by means of two profiles (4, 5) with engaged matching sections, the shutter furthermore being of the type in which the slats are inserted between the profiles (4, 5) and in which the profiles and/or the slats slide, at either end thereof, in a vertical lateral slide (6) attached to the opening (∂′) which delimits the window to be protected, characterized in that each one of the slats thereof is made up of a plurality of I-section modules (7, 12) assembled two-by-two in a laterally overlapping fashion, the top (20) and bottom (21) flanges of said modules being inserted by sliding between two opposing rails (22, 23), provided on the surfaces of the profiles opposite the locking surfaces thereof, respectively the top profile (4) and the bottom profile (5), and in that each extremal module of each slat ends in a breakable fixing peg (27).

### FIELD OF THE INVENTION

The present invention relates to a transparent security shutter, of the type that can be wound about a drum arranged at the top thereof, said shutter, when it is lowered and closed, enabling a shop window or a storefront for example, to be protected against vandalism and burglary, without affecting its visibility, or also enabling a window or a patio-door of residential buildings to be protected, said window being further constituted of a plurality of transparent slats, arranged horizontally on top of one another.

### BACKGROUND OF THE INVENTION

Currently two main types of such transparent security shutters are known.

In the first type, described for example in international patent application published under N^{o} WO2007/024131, in the name of Europ Look Beheer B.V., the transparent laths have as protuberances, on each of their two longitudinal sides, sections of staggered cylindrical tubes, wherein the length of each section is very slightly less than the distance separating two consecutive sections. In order to join two laths of this kind, the tube sections from one are placed in the intervals left between the tube sections of the other and the two laths thus arranged are assembled by sliding inside the cylindrical tubular sections thus arranged in the extension of one another a rod whose diameter is very slightly less than the inside diameter of the tubular sections.

Thus, like a piano hinge, the rod constitutes a bolt and a horizontal articulation axis for the two laths in question. The laths, which are made of one piece with their cylindrical tube sections forming protuberances, are generally of polycarbonate and the articulation rods are of steel.

In the second type, described for example in French patent FR-87.11017 in the name of Peyrichou-Malan, the slats are each united to the slat immediately above by means of two profiles with engaged matching sections. These two interlocking profiles simultaneously also constitute a lock and a horizontal articulation axis for the two slats in question. In this type of shutter, transparent slats are inserted between the profiles and either the slats or the profiles slide at each of their two extremities in a vertical lateral slide or guide rail fastened to the woodwork that delimits the window or storefront to be protected. The slats or such a shutter are generally of polycarbonate and the profiles are preferably of aluminum.

The transparent security shutter according to the invention constitutes an improvement of the shutters of the second type described here above.

In fact, as the widths of the shop windows or storefronts as well as the widths of the windows are variable, it is necessary to provide or cut on location the slats to a length corresponding to the opening to be covered, furthermore taking into account the dimensions and the thicknesses of the vertical lateral slides.

Such slats are thus particularly bulky. Furthermore, if an error is made during cutting, the slats cannot be used, at least not for the opening they were supposed to cover, and they are then either discarded or stored in the hope of being re-usable for covering an opening with a slightly narrower width.

Furthermore, as the transparent slats are press-inserted into corresponding hollows provided in the surfaces of the profiles opposite their locking surfaces, each security shutter of the second type must be integrally mounted before being placed between the two vertical lateral slides, by sliding it through their top part, which means that in order to accomplish all required preliminary operations, the installer needs to have a large volume available inside the shop to be equipped.

### GENERAL DESCRIPTION OF THE INVENTION

Thus, the transparent security shutter according to the invention is characterized in that each one of its slats is made up of a plurality of I-section modules assembled two-by-two in a laterally overlapping fashion, the top and bottom flanges of said modules being inserted by sliding with a small play between two opposing rails provided on the surfaces of the profiles opposite the locking surfaces thereof, respectively the top profile and the bottom profile, and in that each extremal module of each slat is joined to a breakable fixing peg.

The modules are assembled either by simple overlap or by being press-interlocked.

In each of the two aforementioned embodiments, the modules have a length of several tens of centimeters, and are preferably on the order of 30 centimeters.

In the first of the two aforementioned embodiments, the modules comprise on each of their vertical lateral sides a Z-shaped protrusion, with the extremal flange of this protuberance being staggered relative to the core of the module whilst being parallel to said core, and the plane of the inside surface of said extremal flange being one with the plane of the core's face in the direction into which the protuberance is staggered.

In this construction, the protuberances in Z formed along the two lateral edges of each module then advantageously have an opposite orientation so that the inside surface of each extremal flange is in contact with the face of the core of a neighboring module.

In the second of the two aforementioned embodiments, the press-interlocking of the two modules is achieved by a hook locking, formed along the vertical edge of each module, in a complementary vertical groove hollowed out in the core in proximity to the vertical edge of the other module, slightly further back from its hook.

Very advantageously, in this second embodiment, the two hooks formed along the two vertical edges of each module have an opposite orientation and the two vertical grooves are hollowed out one in one face and the other in the other face of the core of said module.

Advantageously, each fixing peg is comprised of a base whose width is more or less equal to that of the profiles and whose height is more or less equal to the distance separating the centers of the two matching rounded sections constituting the locking means of two profiles mounted on a same slat, wherein said base is extended by a core that is perpendicular thereto and whose cross section is more or less identical to that of the modules, said core being extended in upper and lower parts by an orthogonal return extending on each side of the core, with a greater thickness than the flange of a module and thus press-sliding in the rail of a profile, said core further comprising at its free extremity a plurality of vertical slits making cutting and perfect length-fitting of the core easier so that its end piece comes into contact with the extremal module of the slat whose ending it constitutes.

Preferably, the base of each fixing peg is provided with two through holes perpendicular to the channels of the rails of the two profiles mounted on a same slat and each hole receives a screw whose threaded shank comes to be screwed in the central part of the orthogonal return press-mounted to slide in a rail.

Each of the two returns of the core of each fixing peg also preferably has on its outer surface a longitudinal groove that receives the threaded shaft in order for the thread of said screw to work with the bottom of said groove and with the bottom of the profile's rail.

Advantageously, said longitudinal groove extends from the base of the fixing peg up to the first vertical slit.

In order to make each fixing peg easily breakable, each vertical slit is made so as to leave only some parts of the core's material, said parts of material being spaced and furthermore having a reduced thickness.

In order to make the transparent security shutter according to the invention as secure as possible, both regarding vandalism as well as with respect to violent atmospheric disturbances (wind gusts, storms), only a limited lateral displacement movement is possible for the fixing pegs between the flanges of each vertical slide.

Preferably, the lower transparent slat is articulated on a final slat of extruded aluminum that is provided at its lower part of a rail capable of receiving a sealing joint and that is provided with an element enabling it to be locked in the lower part of the shop window or storefront to be protected.

The detailed specifications of the invention are given in the following description in connection with the drawings attached hereto. It must be noted that these drawings have no other purpose than to illustrate the text of the description and that they do not constitute in any way a limitation of the scope of the invention.

### BRIEF DESCRIPTION OF THE DRAWINGS

FIG. 1 represents diagrammatically a front view of a storefront equipped of the transparent security shutter according to the invention in its preferred embodiment according to which the modules are placed in staggered fashion.

FIGS. 2 and 3 represent respectively a front view and a profile view of a final slat in extruded aluminum articulated on the lowest transparent slat of the shutter.

FIG. 4 is a profile view of the rubber sealing joint designed to equip the rail provided at the lowest part of the final slat.

FIGS. 5, 6 and 7 are respectively a front view, a top view and a side view of the embodiment of a proposed single-overlap module.

FIG. 8 is a detailed view of one and the other of the two extremities of the module represented in FIGS. 5 and 7.

FIGS. 9, 10 and 11 are respectively a front view, a top view and a side view of the second embodiment of a module, namely the one wherein the modules are press-interlocked, with the right side of the top view being represented in cross section.

FIG. 12 is a detailed view of one and the other of the two extremities of the module represented in FIGS. 9 to 11.

FIG. 13 is a perspective view of the module represented in FIGS. 9 to 11.

FIG. 14 is a side view of a fixing peg.

FIG. 15 is a cross section view of the fixing peg represented in FIG. 14.

FIG. 16 is a top view of the fixing peg represented in FIGS. 14 and 15.

FIG. 17 is a front view of the fixing peg of FIGS. 14 to 16, illustrating the result achieved after performing a cut-out schematized by the arrow A.

FIG. 18 is a perspective view of the fixing peg represented in FIGS. 14 to 16.

FIG. 19 illustrates the preparations for assembling the fixing peg on two matching profiles, respectively on the upper one and lower one.

FIG. 20 is a perspective view of the fixing peg mounted onto the two matching profiles.

FIG. 21 is a side view in cross section of the assembly of FIG. 20.

FIG. 22 is a detailed view of FIG. 21.

FIG. 23 is a front view of the assembly of FIGS. 20 and 21.

FIG. 24 is a perspective view of the extremity of a completely mounted slat.

FIG. 25 is a side view of a module mounted between its two matching profiles, a view in which the module has been merely schematized.

FIG. 26 is a side view illustrating the locking of two matching profiles.

FIG. 27 represents in a perspective view the mounting of the transparent security shutter according to the invention in a vertical lateral slide, wherein the shutter is simply illustrated by its top profile.

FIG. 28 represents in perspective the mounting of the transparent security shutter according to the invention in a vertical lateral slide, wherein the shutter is simply illustrated by the modules of the second embodiment whose most extreme one is joined to a breakable fixing peg.

FIG. 29 is a perspective view illustrating the overlapping of two modules designed according to the first embodiment.

### DESCRIPTION OF PREFERRED EMBODIMENTS OF THE INVENTION

A transparent security shutter according to the invention has been represented in FIG. 1.

This shutter 1, of the type that can be wound about a drum arranged at the top thereof, for example built into a cassette 2, when it is lowered and closed, enables a shop window or a storefront for example, to be protected against vandalism and burglary, without affecting its visibility, or also enables a window or a patio-door of a residential building, for example a villa or an apartment in a block of flats, to be protected.

To this effect, the shutter is constituted of a plurality of transparent slats 3 arranged horizontally on top of one another, and each connected to the immediately higher slat by means of two profiles with engaged matching sections, respectively upper profile 4 and lower profile 5, as can be seen in FIGS. 25 and 26.

When they are engaged in pairs, the profiles 4 and 5 simultaneously constitute a bolt and a horizontal articulation axis for the two slats 3 in question.

The shutter according to the invention is furthermore of the type in which the slats 3 are inserted between the profiles 4 and 5 and wherein the profiles 4,5 and/or the slats 3 slide at each of their two extremities in a vertical lateral slide or guide rail 6 fastened to the woodwork 6′ that delimits the window or storefront to be protected.

According to the invention, each of the slats 3 of the security shutter 1 is made up of a plurality of I-section modules 7 or 12 assembled two-by-two in a laterally overlapping fashion.

According to its first embodiment represented in FIGS. 5 to 8 and 29, the modules 7, which very advantageously yet not in any limiting way have a width on the order of 30 centimeters, are assembled by simple overlap.

To this effect, the two vertical lateral edges 9 and 10 of the core 8 of each module 7 are slightly tapered and bent twice in opposite direction in order to form a Z-shaped protuberance 11. The extremal flange of this Z-shaped protuberance is thus staggered relative to the core 8 whilst being parallel to said core, and the plane of the inside surface 11′ of said extremal flange is one with the plane of the core's face 11″ in the direction into which it is staggered.

Furthermore, in this first embodiment, the Z-shaped protuberances 11 formed along the two lateral edges 9 and 10 of each module 7 have opposite orientations. Thus, the modules 7 integrated between the rails 4 and 5 one after the other to constitute a slat 3 can be assembled, joined two by two with simple overlap overlapping of the extremal flanges of the two Z-shaped protuberances, wherein the inside surface 11′ of said two Z-shaped protuberances 11 are slightly staggered relative to one another and are in contact with the face 11″ of the core 8 of the immediately neighboring module 7, as is clearly visible in FIG. 29.

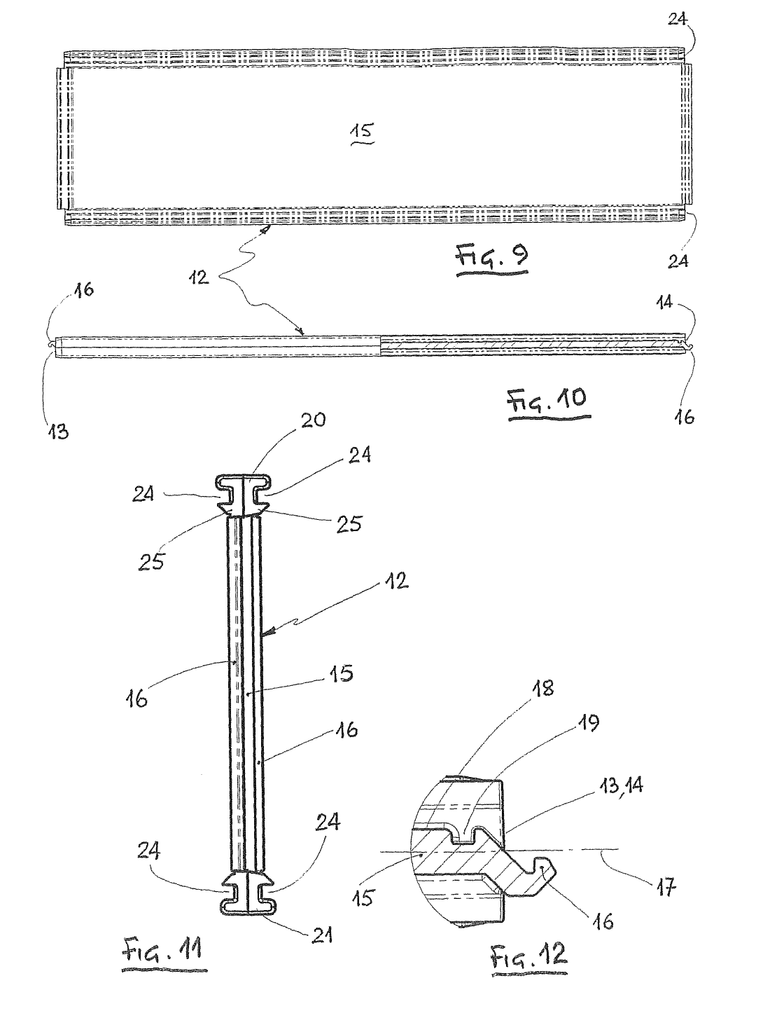

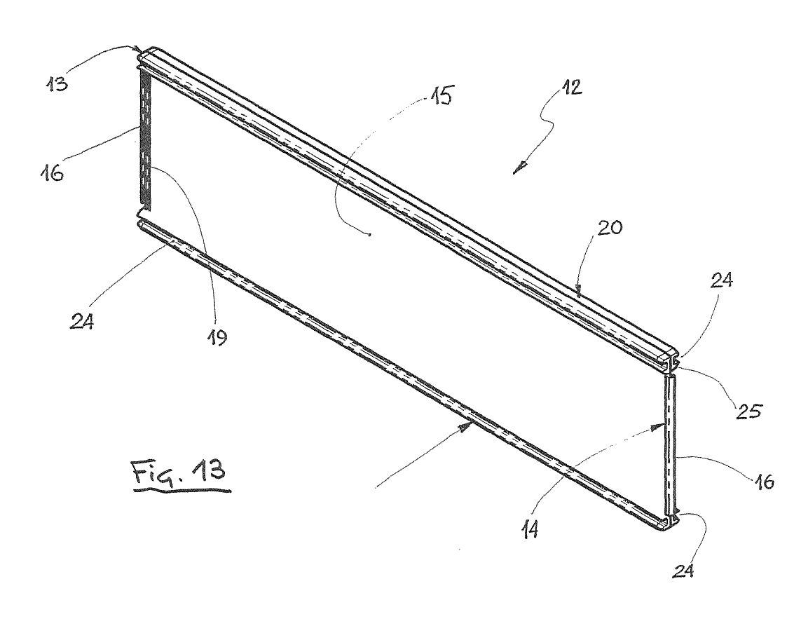

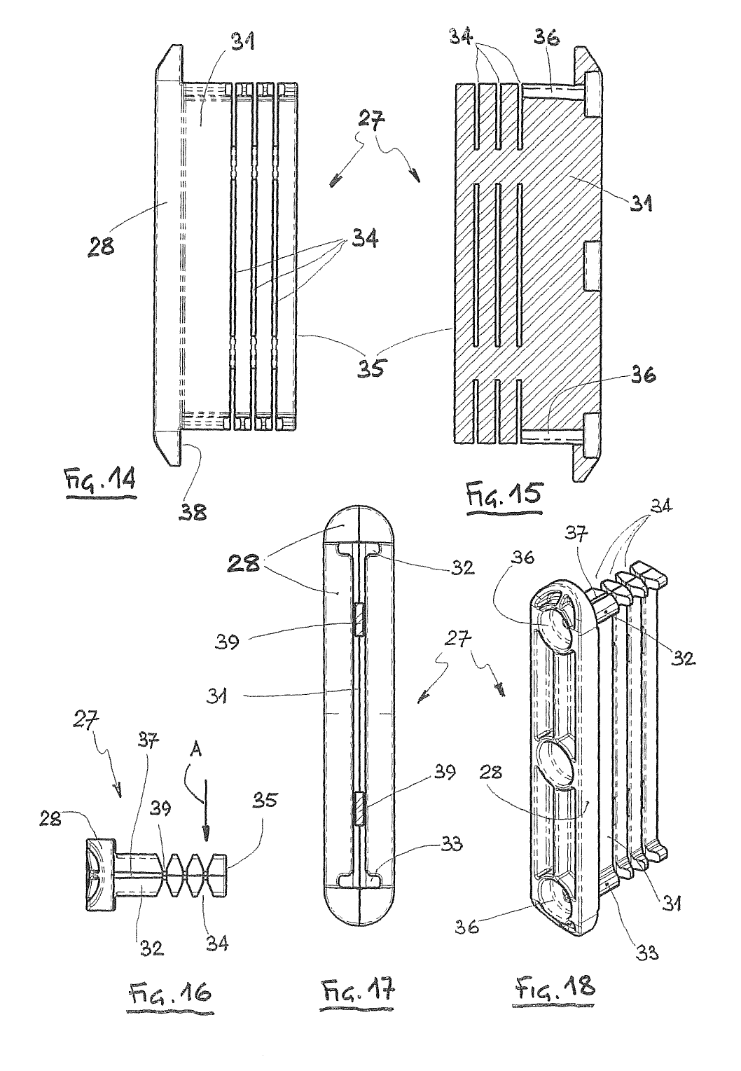

In the second embodiment represented in FIGS. 9 to 13, the modules 12, which preferably also have a width on the order of 30 centimeters, are press-interlocked.

To this effect, each of the two lateral extremities 13 and 14 of the core 15 of each module 12 is bent three times so as to form a vertical hook 16 that is turned towards the median plane 17 but does not reach this median plane.

The face 18 of the core 15 of each module towards which the hook 16 is turned further exhibits a vertical groove 19 capable of receiving the identical hook 16 of another module.

Thus, when two modules 12 are moved closer to one another, their two hooks 16 pass one above the other and then, when the two modules are joined, each hook 16 of each module 12 comes to be press-fitted into the groove 19 of the other module, hence the two modules 12 are interlocked and self-locked.

In the two aforementioned embodiments, the top flanges 20 and bottom flanges 21 of the modules 7, 12 are inserted by sliding with a small play between two opposing rails 22 resp. 23 of the top profiles 4 and bottom profiles 5, wherein the rails are provided each on the surface of the profile that is opposite the surface used for locking.

Each flange 20, 21 comprises to this effect two channels 24 opposite one another, delimited each by the head of the flange 20, 21 as such and by a shoulder 25, wherein the channels 24 are capable of working with the returns 26 of the rails 22, 23 and, to this effect, having a width slightly greater than the thickness of the returns 26. The height of the heads of the flanges 20, 21 is of course, for the same reasons, slightly less than the height of the inside channels of the rails 22, 23.

Since after assembly the modules 7, 12 have been made to slide between the profiles 4 and 5 and have been adjusted one relative to the others, either by simple overlap as regards the modules 7 or interlocked by their hooks 16 and their grooves 19 as regards the modules 12, it will be understood that since there is only a very slight play between the flanges 20 and 21 of the modules 7 or 12 and the rails 22 and 23 of the profiles 4, 5, it is impossible for the modules to become dislocated and for the slats to be thus disassembled.

The succession of the modules 7 or 12 between two rails 4 and 5 has a length that does not necessarily correspond to the width available between the two vertical slides 6 of the shop window or storefront or also of the window to be protected.

In order to approach this width as closely as possible, a section 41 of the module 7 or 12 appropriate to the already executed construction will consequently be placed at least close to one of the vertical slides 6 and, at each of the two extremities of the slat 3 thus made up, the construction will be completed by integrating between the two profiles 4 and 5 a fixing peg 27 according to the invention that will join with a lateral edge of the module 7 or 12 or, depending on circumstances, a lateral edge of a section 41 of such a module designed, as had been stated above, to approach as closely as possible the desired width defined between the bottoms of the core of both slides 6.

In order to achieve the ideal slat length, each fixing peg is designed to be breakable.

To this effect, each fixing peg 27 is comprised of a base 28 whose width is more or less equal to that of the profiles 4 and 5 and whose height is more or less equal to the distance D separating the centers of the two matching rounded sections, respectively the upper one 29 and lower one 30, of the profiles 4 and 5, which being rounded, as can be seen in FIGS. 25 and 26, are complementary for the purpose of constituting the upper and lower locking means of two profiles mounted on a same slat 3.

The base 28 of the fixing peg 27 is extended by a core 31 that is perpendicular thereto and whose cross section is more or less identical to that of the modules 7 or 12.

The core 31 is extended in upper and lower parts by an orthogonal return 32 resp. 33 extending on each side of the core, with a greater thickness than the top flange 20 and bottom flange 21 of a modules 7 or 12, and which thus press-slides in the rail of each profile.

The core 31 of the fixing peg 27, including the returns 32 and 33, further comprises at its free extremity a plurality of vertical slits 34 making it easier to cut part of the core 31 and perfectly fit in terms of length said core and said returns so that its end piece 35 comes into contact with the extremal module of the slat 3 whose ending it constitutes or into contact with the section of the module 41 ending the slat.

For its fastening to the shutter, the base 28 of each fixing peg 27 is provided with two through holes 36 perpendicular to the channels of the rails 22, 23 of the two profiles 4, 5 mounted on a same slat 3 and each hole 36 receives a screw 40 whose threaded shank comes to be screwed in the central part of the orthogonal return 32, 33 press-mounted to slide in a rail 22, 23.

Each of the two returns 32, 33 of the core 31 of each fixing peg 27 also has on its outer surface a longitudinal groove 37 that receives the threaded shaft of the screw 40 in order for the thread of said screw, after working with the material of the base 28 of the fixing peg 27, to work with the bottom of said groove 37 and with the bottom of the rail 22, 23 of the profile 4, 5.

The longitudinal groove 37 extends from the lower part 38 of the base 28 of the fixing peg 27 up to the first vertical slit 34.

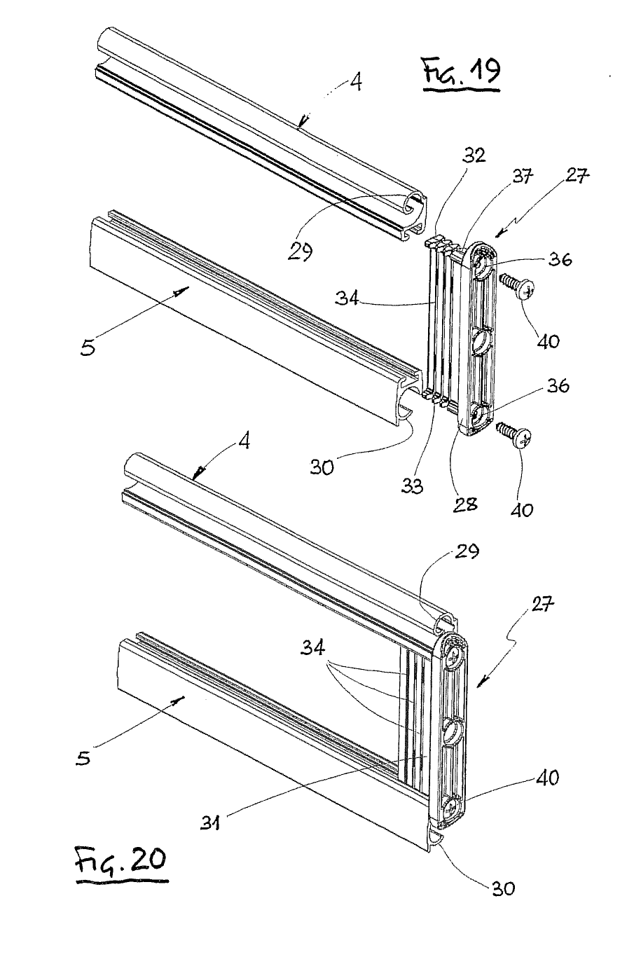

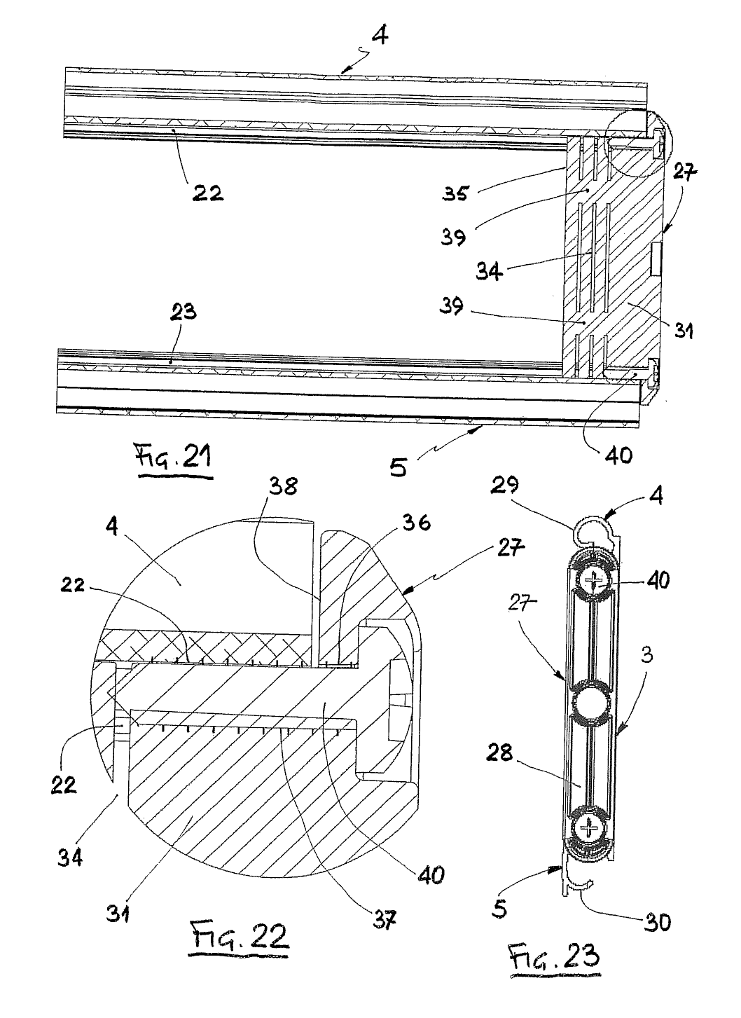

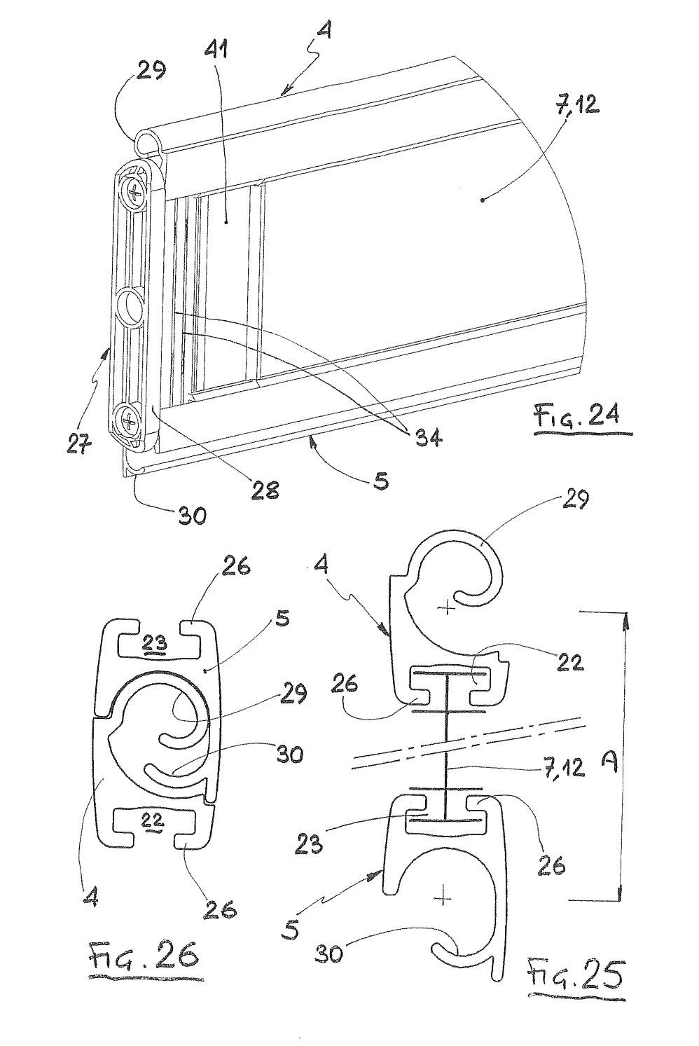

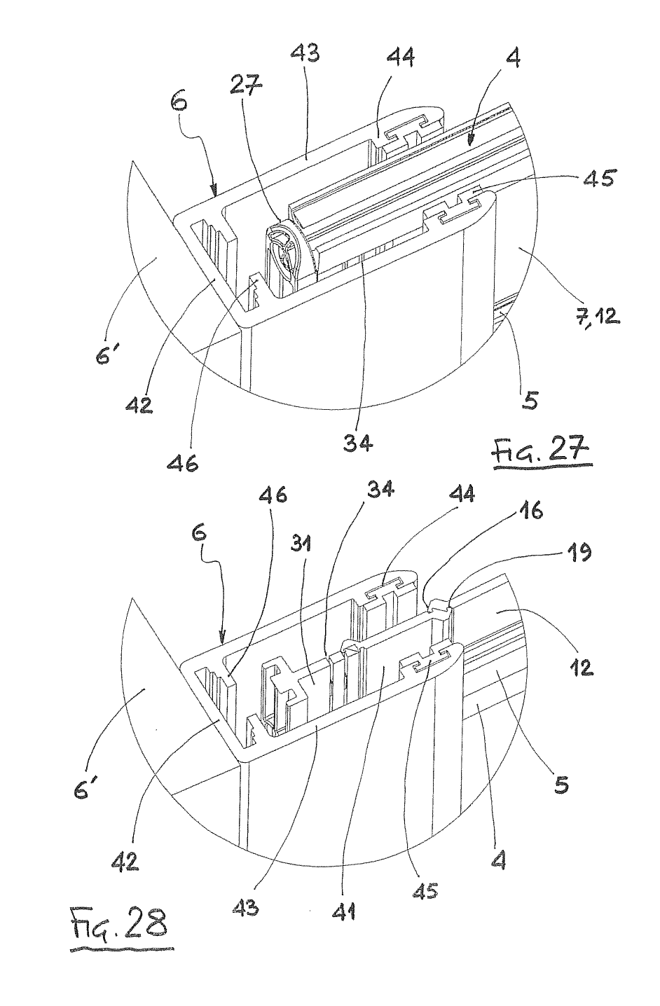

As can be seen in FIGS. 14 to 18, each vertical slit 34 is made in the core 31 and in the returns 32, 33 of the fixing peg 27 so as to leave only some parts 39 of the material from the core 31, said parts of material being spaced and furthermore having a reduced thickness.

It will be understood that these pre-cuttings made in the core 31 and in the returns 32, 33 greatly facilitate the tearing off of one, two or three parts of the extremity of the fixing peg 27, as has been indicated by way of example in FIGS. 14 to 18.

It will also be understood that except in the case where it is not useful to reduce the length of a fixing peg 27, the end piece 35 of said fixing peg is thus constituted only by some parts of its core's material, two in the example represented in FIG. 17 and in FIG. 28 after cutting, schematized in FIG. 16 by the arrow A.

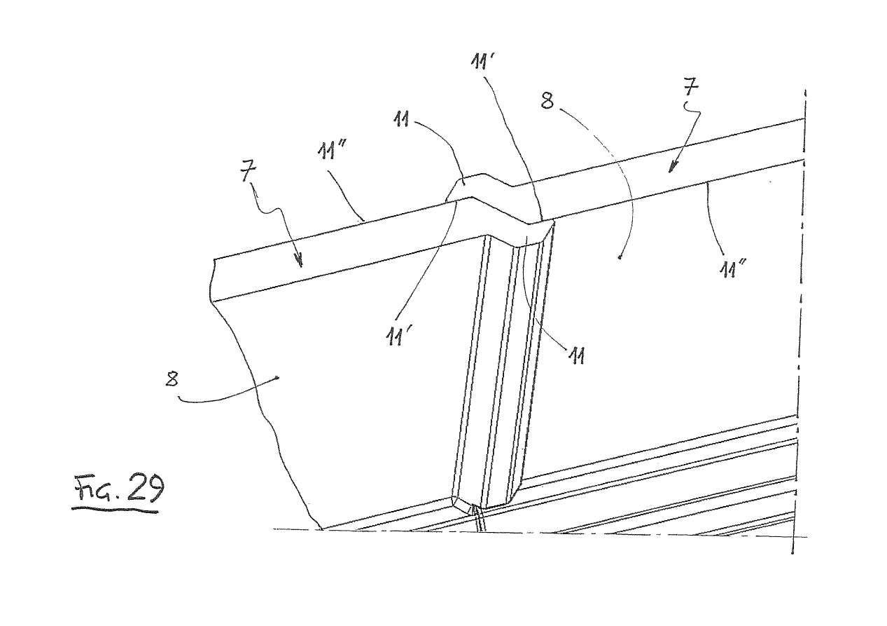

As has been represented in FIGS. 27 and 28, the shutter constituted in the manner described above is, in a manner known as such, introduced at each of its two extremities in a vertical lateral slide 6 constituted in the form of a U-shaped profile whose core 42 is fastened to the woodwork and whose two flanges 43 frame the shutter. The inside of the extremity of each flange 43 advantageously presents a lodging 44 that receives a rubber joint 45 designed to protect the shutter. In order to restrict sideways movements of the shutter, it is possible to provide slightly forwards of the bottom of the core 42 of the slide 6 two shoulders 46, said shoulders being then spaced away from one another by a distance sufficient to allow the various fastening screws to pass through from the slide 6 into the woodwork—wall or frame—that supports said slide.

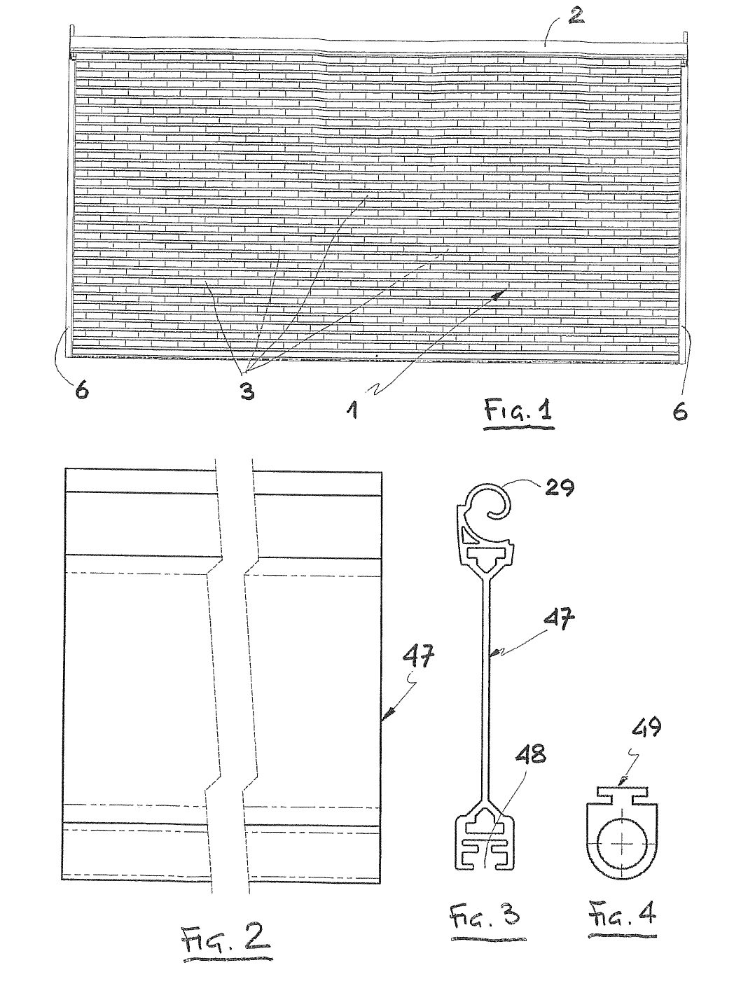

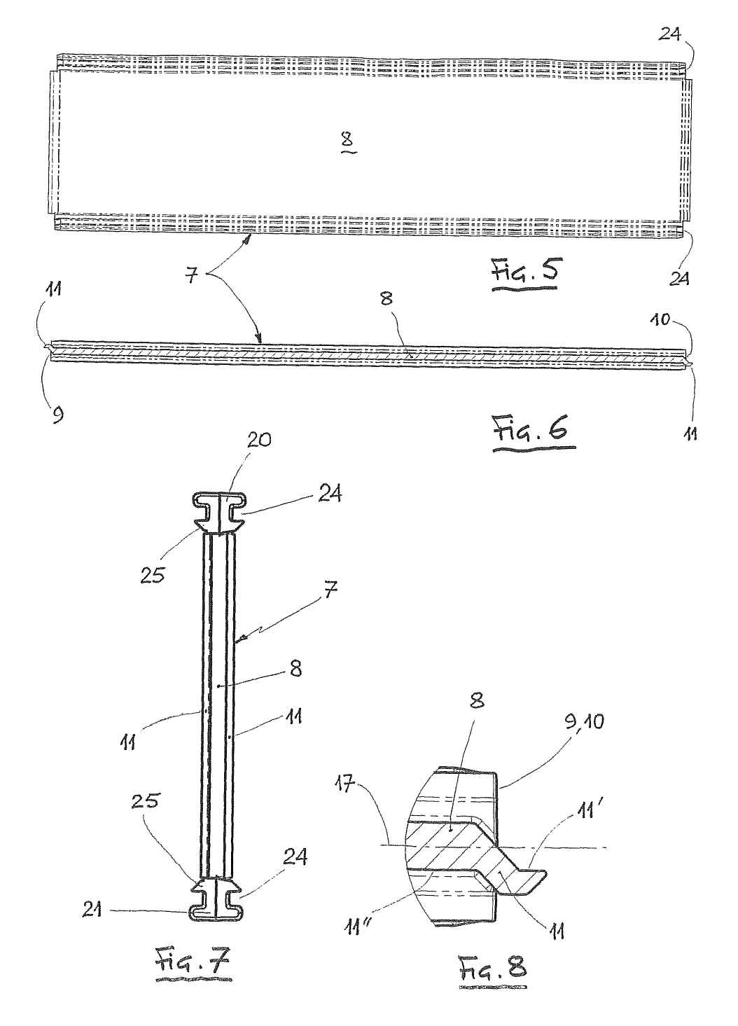

Finally, still in a manner known as such, the lowest slat 3 of the shutter, i.e. the lower profile 5 of this slat, is extended by being articulated on a final slat 47 of extruded aluminum that is provided at its upper part of a locking means similar to that of an upper profile 4, i.e. having a rounded section 29, and which is provided at its lower part with a rail 48 capable of receiving a sealing joint 49 (see FIGS. 2 to 4).

This final slat 47 is further provided with an element enabling it to be locked in the lower part of the shop window or storefront to be protected.

The modules 7 and 12 and the sections 41 of such modules are made of polycarbonate and are produced by injection.

The fixing pegs 27 are made either of polycarbonate or of metal, for example of steel.

The profiles 4 and 5 are preferably made of aluminum and the vertical lateral slides 6 are of metal, either of aluminum or of galvanized steel.

In the shutter's construction, the modules 7 or 12 are either aligned one on top of the other or, preferably and for the sake of a better aesthetics, placed staggered as represented in FIG. 1.

1. Transparent security shutter (1), of the type that can be wound about a drum arranged at the top thereof, said shutter, when it is lowered and closed, enabling a shop window or a storefront for example, or also a window or a patio-door of a residential building, to be protected against vandalism and burglary, without affecting its visibility, said shutter being constituted of a plurality of transparent slats (3) arranged horizontally on top of one another, and each connected to the immediately higher slat (3) by means of two profiles (4, 5) with engaged matching sections, that simultaneously constitute a bolt and a horizontal articulation axis for the two slats (3) in question, wherein the shutter is furthermore of the type in which the slats (3) are inserted between the profiles (4, 5) and wherein the profiles and/or the slats slide at each of their two extremities in a vertical lateral slide or guide rail (6) fastened to the woodwork (6′) that delimits the window or storefront to be protected, and being characterized in that each of its slats (3) is made up of a plurality of I-section modules (7, 12) assembled two-by-two in a laterally overlapping fashion, wherein the top (20) and bottom (21) flanges of said modules being inserted by sliding with a slight play between two opposing rails (22, 23), provided on the surfaces of the profiles (4, 5) opposite the locking surfaces thereof, and in that each extremal module of each slat (3) ends in a breakable fixing peg (27).

2. Transparent security shutter (1) according to claim 1, characterized in that the modules (7) are assembled by simple overlap.

3. Transparent security shutter (1) according to claim 2, characterized in that the modules (7) have on each of their two vertical lateral edges (9, 10) a Z-shaped protuberance (11), wherein the extremal flange of this protuberance (11) is staggered relative to the core (8) of the module (7) whilst being parallel to said core, and the plane of the inside surface (11′) of said extremal flange is one with the plane of the core's face (11″) in the direction into which it is staggered.

4. Transparent security shutter (1) according to claim 3, characterized in that the Z-shaped protuberances (11) formed along the two lateral edges (9, 10) of each module (7) have opposite orientations so that the inside surface (11′) of each extremal flange is in contact with the face (11″) of the core (8) of a neighboring module.

5. Transparent security shutter (1) according to claim 1, characterized in that the modules (12) are press-interlocked.

6. Transparent security shutter (1) according to claim 1, characterized in that the modules (7, 12) have a width of several tens of centimeters, and preferably on the order of 30 centimeters.

7. Transparent security shutter (1) according to claim 5, characterized in that the press-interlocking of the two modules (12) is achieved by a hook locking (16), formed along the vertical edge (13, 14) of each module, in a complementary vertical groove (19) hollowed out in the core (15) in proximity to the vertical edge (13, 14) of the other module, slightly further back from its hook (16).

8. Transparent security shutter (1) according to claim 7, characterized in that the two hooks (16) formed along the vertical edge (13, 14) of each module (12) have opposite orientations and the two vertical grooves (19) are hollowed out one in one face (18) and the other in the other face (18) of the core (15) of said module (12).

9. Transparent security shutter (1) according to claim 1, characterized in that each fixing peg (27) is comprised of a base (28) whose width is more or less equal to that of the profiles (4, 5) and whose height is more or less equal to the distance (D) separating the centers of the two matching rounded sections (29, 30) constituting the locking means of two profiles (4, 5) mounted on a same slat (3), wherein said base (28) is extended by a core (31) that is perpendicular thereto and whose cross section is more or less identical to that of the modules (7, 12), said core being extended in upper and lower parts by an orthogonal return (32, 33) extending on each side of the core (31), with a greater thickness than the flange of a module and thus press-sliding in the rail (22, 23) of a profile (4, 5), said core (31) further comprising at its free extremity a plurality of vertical slits (34) making cutting and perfect length-fitting of the core easier so that its end piece (35) comes into contact with the extremal module of the slat (3) whose ending it constitutes.

10. Transparent security shutter (1) according to claim 9, characterized in that the base (28) of each fixing peg is provided with two through holes (36) perpendicular to the channels of the rails (22, 23) of the two profiles (4, 5) mounted on a same slat (3) and in that each hole (36) receives a screw (40) whose threaded shank comes to be screwed in the central part of the orthogonal return (32, 33) press-mounted to slide in a rail.

11. Transparent security shutter (1) according to claim 10, characterized in that each of the two returns (32, 33) of the core (31) of each fixing peg (27) has on its outer surface a longitudinal groove (37) that receives the threaded shaft of the screw (40) in order for the thread of said screw to work with the bottom of said groove and with the bottom of the rail (22, 23) of the profile (4, 5).

12. Transparent security shutter (1) according to claim 11, characterized in that the longitudinal groove (37) extends from the base (28) of the fixing peg (27) up to the first vertical slit (34).

13. Transparent security shutter (1) according to claim 9, characterized in that each vertical slit (34) is made so as to leave only some parts (39) of material of the core (31), said parts of material (39) being spaced and furthermore having a reduced thickness.

14. Transparent security shutter (1) according to claim 1, characterized in that the fixing pegs (27) have a limited lateral displacement movement between the two flanges (47) of each vertical slide (6).

15. Transparent security shutter (1) according to claim 1, characterized in that the lower transparent slat (3) is articulated on a final slat (47) of extruded aluminum that is provided at its lower part of a rail (48) capable of receiving a sealing joint (49) and that is provided with an element enabling it to be locked in the lower part of the shop window or storefront to be protected.

16. Transparent security shutter (1) according to claim 1, characterized in that from one slat (3) to the next, the modules (7, 12) are placed in staggered fashion.
